(19) United States
(12) Patent Application Publication
(10) Pub. No.: US 2022/0270480 A1
(43) Pub. Date: Aug. 25, 2022

(54) SIGNAL CONTROL APPARATUS AND METHOD BASED ON REINFORCEMENT LEARNING

(71) Applicant: LAON ROAD INC., Seongnam-si Gyeonggi-do (KR)

(72) Inventors: Suk Joong LEE, Seoul (KR); Tae Wook CHOI, Seongnam-si, Gyeonggi-do (KR); Dae Seoung KIM, Seoul (KR); Hee Bin LEE, Incheon (KR)

(73) Assignee: LAON ROAD INC., Seongnam-si Gyeonggi-do (KR)

(21) Appl. No.: 17/422,779

(22) PCT Filed: Mar. 30, 2021
(86) PCT No.: PCT/KR2021/003938

§ 371 Date: Jul. 14, 2021

(30) Foreign Application Priority Data
Mar. 30, 2020 (KR) 10-2020-0038586
Mar. 30, 2021 (KR) 10-2021-0041123

(51) Int. Cl. G08G 1/081; G08G 1/01; G06V 20/54; G06N 3/08; G06N 5/04

(52) U.S. Cl. CPC G08G 1/081; G08G 1/0133; G06V 20/54; G06N 3/08; G06N 5/04

(57) ABSTRACT

Proposed herein are a signal control apparatus and method. The signal control apparatus includes: a photographing unit configured to acquire a plurality of intersection images by capturing a plurality of intersections; a storage configured to store a program for the control of traffic signals; and a controller including at least one processor, and configured to calculate control information for the control of traffic lights at each of the plurality of intersections using the intersection images acquired through the photographing unit by executing the program. The controller calculates control information for the control of traffic lights at each of the plurality of intersections based on action information calculated by a plurality of agents by using a plurality of agents based on a reinforcement learning model trained by outputting action information for the control of traffic lights while using state information and a reward as input values.

### TECHNICAL FIELD

The embodiments disclosed herein relate to a signal control apparatus and method based on reinforcement learning, and more particularly to an apparatus and method for controlling traffic signals at a plurality of intersections.

### BACKGROUND ART

Recently, as the number of people who purchase vehicles for convenience of life or professional reasons increases, the number of vehicles running on roads is increasing. Traffic difficulties are increasing due to an increase in the number of such vehicles, and traffic difficulties may occur due to various factors such as a road environment, a driver situation, a vehicle breakdown, and a vehicle accident.

One of the reasons for the occurrence of traffic difficulties is a problem with a traffic signal system in a road environment. For example, since a traffic signal controls the flow of vehicles and determines the travel direction of vehicles at predetermined time intervals, a traffic jam inevitably occurs when the number of vehicles increases in a specific direction. For this reason, when a traffic jam occurs, a police officer or a related person adjusts traffic flow by directly manipulating a signal controller. Since the method has a limitation in that a person cannot always stand by to control a traffic signal, various attempts have been made to control a traffic signal.

Korean Patent Application Publication No. 10-2009-0116172 entitled ‘Artificial Intelligence Vehicle Traffic Light Control Apparatus,’ which is a related art document, describes a method of analyzing an image captured using an image detector and controlling traffic lights. However, the above-described conventional art has a problem in that it is difficult to achieve the efficiency of a traffic signal system because an artificial intelligence model is only used as a means for detecting the presence of a vehicle in a specific lane by simply analyzing an image, but determining a subsequent signal based on the detected information is performed by a conventional simple operation.

Therefore, there is a need for a technology for overcoming the above-described traffic situations.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

An object of the embodiments disclosed herein is to propose a signal control apparatus and method based on a reinforcement learning model.

Furthermore, an object of the embodiments disclosed herein is to propose a signal control apparatus and method based on a multi-agent based reinforcement learning model.

Furthermore, an object of the embodiments disclosed herein is to propose a signal control apparatus and method that enable smooth traffic flow at a plurality of intersections.

Furthermore, an object of the embodiments disclosed herein is to propose a signal control apparatus and method that resolve the problem in which a control target environment and a learning target environment do not match each other.

Moreover, an object of the embodiments disclosed herein is to propose a signal control apparatus and method that minimize the time spent in traffic simulation.

### Technical Solution

As a technical solution for accomplishing the above objects, according to an embodiment described herein, there is provided a signal control apparatus for controlling traffic signals at intersections based on a reinforcement learning model, the signal control apparatus including: a photographing unit configured to acquire a plurality of intersection images by capturing a plurality of intersections; a storage configured to store a program for the control of traffic signals; and a controller including at least one processor, and configured to calculate control information for the control of traffic lights at each of the plurality of intersections using the intersection images acquired through the photographing unit by executing the program; wherein the controller calculates control information for the control of traffic lights at each of the plurality of intersections based on action information calculated by a plurality of agents, to which state information calculated based on each of the plurality of intersection images is input, by using a plurality of agents based on a reinforcement learning model trained by outputting action information for the control of traffic lights while using state information and a reward as input values.

Furthermore, as a technical solution for accomplishing the above objects, according to an embodiment described herein, there is provided a signal control method by which a signal control apparatus controls traffic signals at intersections based on a reinforcement learning model, the signal control method including: training a reinforcement learning model so that an agent outputs action information for the control of traffic lights by using state information and a reward as input values; acquiring a plurality of intersection images by capturing a plurality of intersections; and calculating control information for the control of traffic lights at each of the plurality of intersections by using the acquired intersection images; wherein calculating the control information includes calculating control information for the control of traffic lights at each of the plurality of intersections based on action information calculated by a plurality of agents, to which state information calculated based on each of the plurality of intersection images is input, by using a plurality of agents based on the trained reinforcement learning model.

### Advantageous Effects

According to one of the above-described technical solutions, there may be proposed the signal control apparatus and method based on a reinforcement learning model.

Furthermore, the embodiments disclosed herein may propose the signal control apparatus and method based on a multi-agent based reinforcement learning model.

Furthermore, the embodiments disclosed herein may propose the signal control apparatus and method that enable smooth traffic flow at a plurality of intersections.

Furthermore, the embodiments disclosed herein may propose the signal control apparatus and method that resolve the problem in which a control target environment and a learning target environment do not match each other.

Moreover, the embodiments disclosed herein may propose the signal control apparatus and method that minimize the time spent in traffic simulation.

The effects that can be obtained by the embodiments disclosed herein are not limited to the above-described effects, and other effects that have not been described above will be clearly understood by those having ordinary skill in the art, to which the present invention pertains, from the following description.

### DESCRIPTION OF DRAWINGS

FIG. 1 is a block diagram showing the configuration of a signal control apparatus according to an embodiment;

FIG. 2 is a diagram showing the schematic configuration of a signal control system including the signal control apparatus according to an embodiment;

FIGS. 3 and 4 are exemplary diagrams illustrating a signal control apparatus according to an embodiment;

FIG. 5 is a diagram showing a general reinforcement learning model;

FIG. 6 is a diagram illustrating the reinforcement learning and signal control process of a signal control apparatus according to an embodiment;

FIG. 7 is a flowchart showing the process of performing reinforcement learning in a signal control method according to an embodiment in a stepwise manner; and

FIG. 8 is a flowchart showing the process of controlling traffic lights using a reinforcement learning model in a signal control method according to an embodiment in a stepwise manner.

### BEST MODE

As a technical solution for accomplishing the above objects, according to an embodiment described herein, there is provided a signal control apparatus for controlling traffic signals at intersections based on a reinforcement learning model, the signal control apparatus including: a photographing unit configured to acquire a plurality of intersection images by capturing a plurality of intersections; a storage configured to store a program for the control of traffic signals; and a controller including at least one processor, and configured to calculate control information for the control of traffic lights at each of the plurality of intersections using the intersection images acquired through the photographing unit by executing the program; wherein the controller calculates control information for the control of traffic lights at each of the plurality of intersections based on action information calculated by a plurality of agents, to which state information calculated based on each of the plurality of intersection images is input, by using a plurality of agents based on a reinforcement learning model trained by outputting action information for the control of traffic lights while using state information and a reward as input values.

Furthermore, as a technical solution for accomplishing the above objects, according to an embodiment described herein, there is provided a signal control method by which a signal control apparatus controls traffic signals at intersections based on a reinforcement learning model, the signal control method including: training a reinforcement learning model so that an agent outputs action information for the control of traffic lights by using state information and a reward as input values; acquiring a plurality of intersection images by capturing a plurality of intersections; and calculating control information for the control of traffic lights at each of the plurality of intersections by using the acquired intersection images; wherein calculating the control information includes calculating control information for the control of traffic lights at each of the plurality of intersections based on action information calculated by a plurality of agents, to which state information calculated based on each of the plurality of intersection images is input, by using a plurality of agents based on the trained reinforcement learning model.

### Mode for Invention

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

The embodiments will be described in detail below with reference to the accompanying drawings.

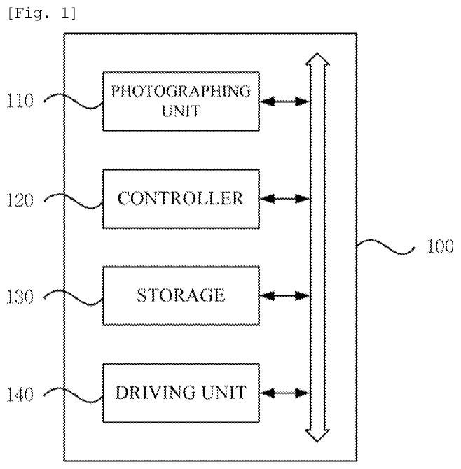

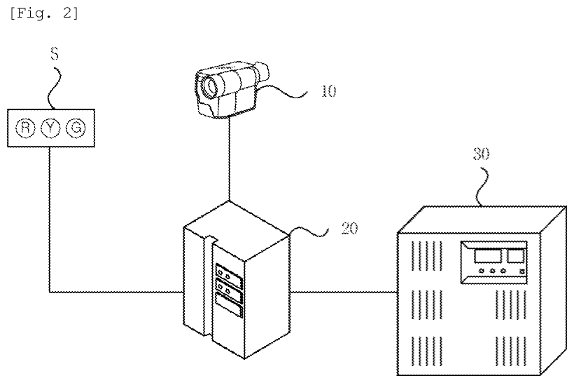

FIG. 1 is a block diagram showing the configuration of a signal control apparatus 100 according to an embodiment, and FIG. 2 is a diagram showing the schematic configuration of a signal control system including the signal control apparatus 100 according to an embodiment.

The signal control apparatus 100 is an apparatus that is installed at an intersection and captures and analyzes an image such as an image of an entry into the intersection or an image of an exit from the intersection. In the following description, an image captured by the signal control apparatus 100 installed at an intersection is referred to as an ‘intersection image.’

As shown in FIG. 1, the signal control apparatus 100 includes a photographing unit 110 configured to capture an intersection image, and a controller 120 configured to analyze the intersection image.

The photographing unit 110 may include a camera configured to capture an intersection image. The photographing unit 110 may include a camera capable of capturing images of wavelengths within a predetermined range, such as that of visible light or infrared light. Accordingly, the photographing unit 110 may acquire an intersection image by capturing an image of a different wavelength region depending on the daytime, the nighttime, or a current situation. In this case, the photographing unit 110 may acquire an intersection image at a preset period.

In addition, the controller 120 may generate at least one of a delay level, a waiting length, a waiting time, a travel speed, and a congestion level by analyzing an intersection image acquired by the photographing unit 110. The information calculated as described above may be used in a reinforcement learning model to be described later.

In order to calculate information by analyzing an intersection image as described above, the controller 120 may process the intersection image so that it can be analyzed, and may identify an object or pixels corresponding to each vehicle in the processed intersection image. Furthermore, to this end, the controller 120 may identify an object corresponding to each vehicle in the intersection image or whether each pixel is a location corresponding to a vehicle by using an artificial neural network.

In this case, the signal control apparatus 100 may include two or more hardware devices so that the photographing unit 110 configured to capture an intersection image and the controller 120 configured to analyze the intersection image captured by the photographing unit 110 communicate with each other and are physically spaced apart from each other. In other words, the signal control apparatus 100 may be configured such that the capturing and analysis of an intersection image are separately performed by hardware devices spaced apart from each other. In this case, the hardware device including the configuration of the controller 120 may receive intersection images from a plurality of different photographing units 110, respectively, and may analyze the intersection images. Furthermore, the controller 120 may be configured to include two or more hardware devices, which may process the intersection images of respective intersections.

Furthermore, the controller 120 may generate a control signal for an intersection based on a delay level obtained by analyzing an intersection image. In this case, the controller 120 may calculate the state information of the intersection and action information by using a reinforcement learning model. To this end, the reinforcement learning model may be trained in advance.

Furthermore, the signal control apparatus 100 may include a storage 130. The storage 130 may store a program, data, a file, an operating system, etc. required for the capturing or analysis of an intersection image, and may at least temporarily store an intersection image or the results of the analysis of an intersection image. The controller 120 may access and use the data stored in the storage 130, or may store new data in the storage 130. Furthermore, the controller 120 may execute the program installed in the storage 130.

Furthermore, the signal control apparatus 100 may include a driving unit 140. The driving unit 140 applies a drive signal to traffic lights S, so that the signal lights S installed at an intersection are driven according to a control signal calculated by the controller 120. Accordingly, environment information may be updated, and state information obtained by observing an environment may be updated.

As described above, the photographing unit 110 of the signal control apparatus 100 is installed at the intersection. Depending on an installation height or location, only one photographing unit 110 is provided at one intersection, or a number of photographing units 110 equal to the number of entries/exits at an intersection may be provided. For example, in the case of a four-way intersection, the signal control apparatus 100 may include four photographing units 110 configured to acquire images of the intersection by capturing four entries/exits separately. Furthermore, for example, when the four photographing units 110 acquire intersection images of four entries/exits, one intersection image may be generated by combining the four intersection images.

The signal control apparatus 100 may be configured to include one or more hardware components, or may be configured as a combination of hardware components included in a signal control system to be described later.

More specifically, the signal control apparatus 100 may be formed as at least a part of the signal control system, as shown in FIG. 2. In this case, the signal control system may include an image detection device 10 configured to capture the above-described intersection image, a traffic signal controller 20 connected to the traffic lights S and configured to apply a drive signal, and a central center 30 configured to control traffic signals while remotely communicating with the traffic signal controller 20.

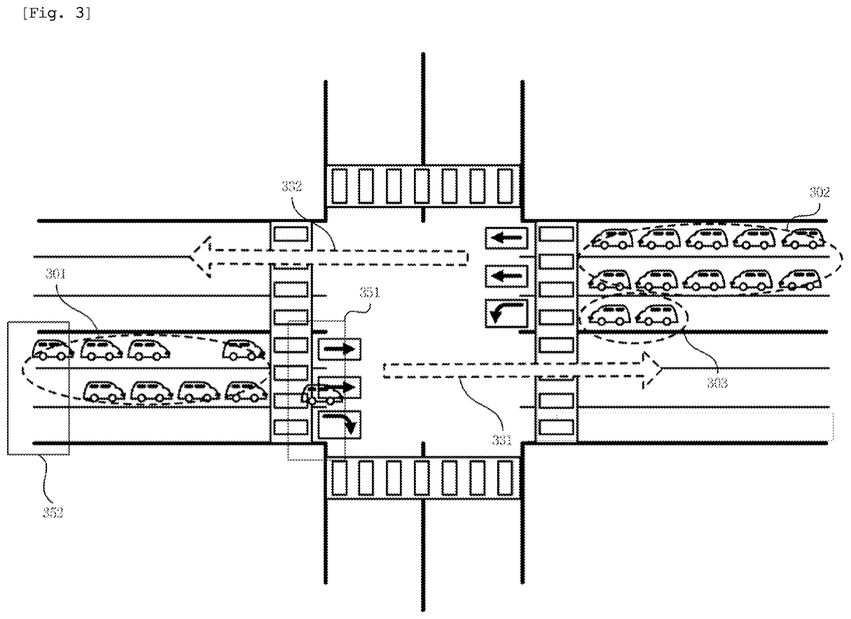

In this case, the traffic signal controller 20 may be configured to include a main control unit, a signal driving unit, and other device units, as shown in FIG. 3. In this case, the main control unit may be configured such that a power supply device, a main board, an operator input device, a modem, a detector board, and an option board are connected to a single bus. The signal driving unit may be configured to include a controller board, a flasher, a synchronous drive device, and an expansion board. In addition, the other device units configured to control other devices such as an image capturing device configured to detect whether a traffic signal is violated may be provided.

The signal driving unit of the traffic signal controller 20 may receive a control signal from the main board, may generate a drive signal for traffic lights according to the control signal, and may apply the generated drive signal to the traffic lights.

In addition, the central center 30 may centrally control a plurality of traffic signal controllers 20 at a plurality of intersections so that they can be controlled in association with each other, or may allow each of the traffic signal controllers 20 to be locally controlled according to the situation of a corresponding one of the intersections. The central center 30 may control the situations of the respective intersections for the purpose of reference when selecting an appropriate control method or generating a specific control signal. For example, the central center 30 may perform control such as changing the start time of a green light at an intersection based on offset time. Furthermore, the central center 30 may directly receive an intersection image captured by the image detection device 10, or may receive a delay level generated by the signal control apparatus 100.

The signal control apparatus 100 may be configured to constitute at least a part of the above-described signal control system, or may be the above-described signal control system itself.

For example, the controller 120 of the signal control apparatus 100 may be provided in the central center 30, the photographing unit 110 may be constructed in the image detection device 10, and the driving unit 140 may be constructed in the traffic signal controller 20.

The operation of the controller 120 of the signal control apparatus 100 will be described in more detail below. The controller 120 may calculate at least one of a delay level, a waiting length, a waiting time, a travel speed, and a congestion level by analyzing an intersection image acquired by the photographing unit 110. The information calculated as described above may be used in a reinforcement learning model to be described later.

In connection with this, FIG. 3 is an exemplary diagram illustrating a signal control apparatus according to an embodiment, which shows an intersection image.

FIG. 3 is an intersection image captured by the photographing unit 110 according to an embodiment. Referring to FIG. 3, the controller 120 may generate at least one of a delay level, a waiting length, a waiting time, a travel speed, and a congestion level by analyzing an intersection image.

According to an embodiment, the controller 120 may calculate a delay level. The delay level may be calculated according to Equation 1 below by measuring arrival traffic fₐ and through traffic f_{d} for a predetermined time T:

∫₀^{T}(fₐ−f_{d}) Equation 1:

In this case, the arrival traffic fₐ is the number of vehicles exiting from an intersection in all through, left-turn, and right-turn directions. For example, when a direction toward the center point of an intersection is an entry direction and a direction away from the center point is an exit direction, the arrival traffic fₐ is the number of vehicles entering into the intersection and then exiting from the intersection, in which case the exit direction is not taken into consideration. The controller 120 may count the number of vehicles located in an area 351 exiting from an intersection at the intersection shown in FIG. 3, and may determine the counted number to be the arrival traffic. Furthermore, the intersection through traffic f_{d} is the number of vehicles in the direction of entry into the intersection, and may be calculated by counting the number of vehicles in a predetermined area 352 for the entry direction. In this case, the predetermined area 352 is an area having a high frequency of rapid changes in vehicle speed, and may be set differently for each intersection. The dimensions of the predetermined area 352 may include the average length of vehicles and the width of lanes constituting the intersection.

In addition, the controller 120 may calculate the waiting length. To this end, the controller 120 may detect the number of vehicles waiting in the intersection. As shown in FIG. 3, vehicles 301 scheduled to move forward in a through direction 331 may be identified among vehicles located on the left side. In the same manner, vehicles 302 scheduled to move forward in a through direction 332 and vehicles 303 scheduled to move in a left direction may be identified among vehicles located on the right side. In this case, the number of waiting vehicles may be counted and the number of vehicles may be calculated as the ‘waiting length,’ or a length occupied by a specific number of vehicles in a lane may be calculated and a calculation result may be calculated as the ‘waiting length.’ Furthermore, the controller 120 may calculate the time required for a waiting vehicle to exit from the intersection as the waiting time. For example, one vehicle located at the intersection may be tracked to calculate the time for which the vehicle has waited in the intersection, or the times for which respective vehicles located in the intersection have waited in the intersection may be averaged and calculated based on a predetermined point in time.

Furthermore, the controller 120 may calculate the travel speed. To this end, the controller 120 may track one vehicle moving in the intersection and calculate the moving speed of the corresponding vehicle as the travel speed, or may calculate the average value of the speeds of all vehicles moving in the intersection as the travel speed.

In addition, the controller 120 may calculate the congestion level. To this end, the controller 120 may calculate the congestion level as the ratio of the number of vehicles currently waiting to the number of vehicles that can be located for each lane area or each driving direction. Accordingly, for example, when vehicles in each lane area or driving direction reach a saturation level, the congestion level is set to 100. The state in which there is no vehicle in each lane area or driving direction may be quantified as 0. Therefore, for example, when 10 vehicles are located in a lane in which 20 vehicles can be located, the congestion level may be calculated as 50.

Meanwhile, in order to generate at least one of a delay level, a waiting length, a waiting time, a travel speed, and a congestion level, the controller 120 may acquire the location coordinates of each object using an artificial neural network that identifies an object estimated to be a vehicle in the intersection image and outputs information about the location of the identified object, or may acquire a bounding box surrounding each object.

More specifically, settings may be made such that the input value of the artificial neural network used by the controller 120 is an intersection image and the output value thereof includes the location information of an object estimated to be a vehicle and the size information of the object. In this case, the location information of the object is the coordinates (x, y) of the center point P of the object, the size information is information about the width and height (w, h) of the object, and the output value of the artificial neural network may be calculated in the form of (x, y, w, h) for the object O. The controller 120 may acquire the coordinates (x, y) of the center point P of each vehicle image as two-dimensional coordinates from the output value. Accordingly, each vehicle in a traffic lane may be identified.

In this case, an available artificial neural network may be, for example, YOLO, SSD, Faster R-CNN, Pelee, or the like, and such an artificial neural network may be trained to recognize an object corresponding to a vehicle in an intersection image.

Furthermore, as another example, the controller 120 may acquire the congestion level information of an intersection by using an artificial neural network that performs segmentation analysis. The controller 120 may extract pixels corresponding to a vehicle by using an artificial neural network that receives an intersection image as an input and outputs a probability map indicating a probability that each pixel included in the intersection image corresponds to a vehicle, may convert the extracted pixels into pixels on the plane of an intersection, and may calculate whether an object is present within a traffic lane according to the number of resulting pixels included in each lane area or the lane area in each driving direction.

In greater detail, the input value of the artificial neural network used by the controller 120 may be an intersection image, and the output value may be a map of the probability that each pixel corresponds to a vehicle. In addition, the controller 120 may extract pixels constituting an object corresponding to a vehicle based on the map of the probability that each pixel corresponds to a vehicle, which is the output value of the artificial neural network. Accordingly, only the pixels of a portion corresponding to the object within the intersection image are extracted separately from other pixels, and the controller 120 may determine the distribution of pixels in the lane area or the lane area in each driving direction. Thereafter, the controller 120 may calculate whether a portion corresponding to a predetermined number of pixels is an object portion according to the number of pixels within a preset area.

In this case, an available artificial neural network may be, for example, FCN, Deconvolutional Network, Dilated Convolution, DeepLab, or the like. Such an artificial neural network may be trained to generate a probability map by calculating a probability that each pixel included in an intersection image corresponds to a specific object, particularly a vehicle.

Then, the controller 120 may train the reinforcement learning model so that an agent outputs action information for the control of traffic lights by using state information and a reward as input values. Furthermore, control information for the control of traffic lights at a plurality of intersections may be calculated based on action information calculated by a plurality of agents, to which state information calculated based on each of a plurality of intersection images is input, by using the plurality of trained reinforcement learning model-based agents.

According to the embodiment, the controller 120 may allow the agent of the trained reinforcement learning model to calculate control information regarding offset time by inputting information about a delay level and a signal pattern at a current point in time, i.e., information about a traffic phase, to the corresponding agent.

In this case, the phase is a signal pattern presented by the traffic lights S. For example, the phase refers to a combination of signals that appear simultaneously at traffic lights in east, west, north, and south directions. In general, a setting is made such that different phases appear sequentially. In addition, the pattern information to be described later means that a plurality of phases is combined together.

Furthermore, the offset time is a value obtained by expressing a difference between the time ranging from a specific reference time to the start time of the green light of first traffic lights and the time ranging from the specific reference time to the turned-on time the green light of subsequent traffic lights in successive intersections based on one direction in seconds (sec) or as the percentage of a period.

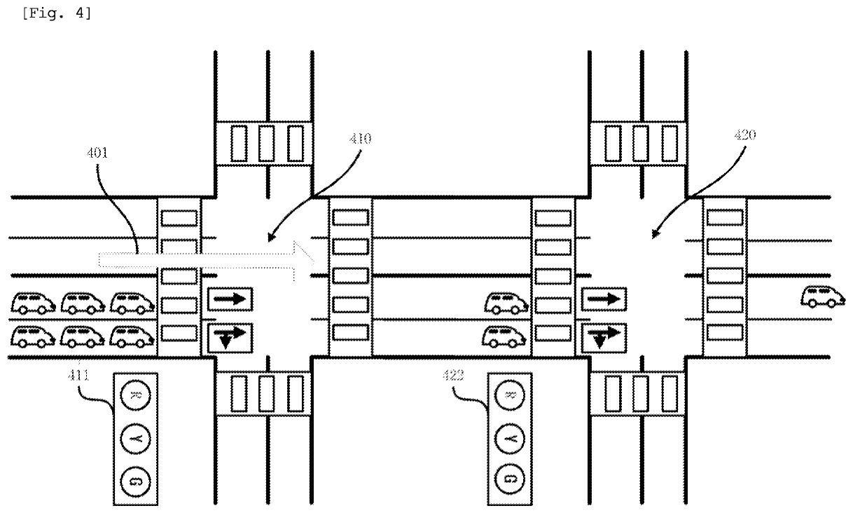

In connection with this, FIG. 4 is an exemplary diagram illustrating a signal control apparatus 100 according to an embodiment, which shows an image of a plurality of intersections.

Referring to FIG. 4, when a vehicle moves in one direction 401, a through vehicle moves through a first intersection 410 and a second intersection 420, and the controller 120 may acquire intersection images of the first and second intersections 410 and 420.

In the following description, for ease of description, an intersection that appears first based on a travel direction is referred to as a ‘first intersection,’ and a subsequent intersection that appears after the first intersection is referred to as a ‘second intersection.’

In this case, the offset time may be a difference between the time until the start time of the green light of first traffic lights 411 that the vehicle encounters at the first intersection 410 and the time until the start time of the green light of first traffic lights 422 that the vehicle encounters at the second intersection 420.

In other words, the controller 120 may use the reinforcement learning model to calculate the offset time as control information based on state information such as a delay level.

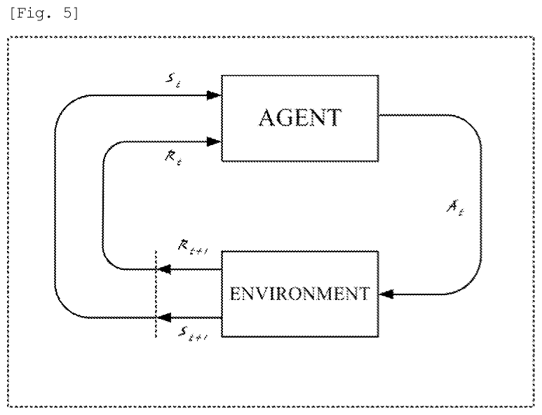

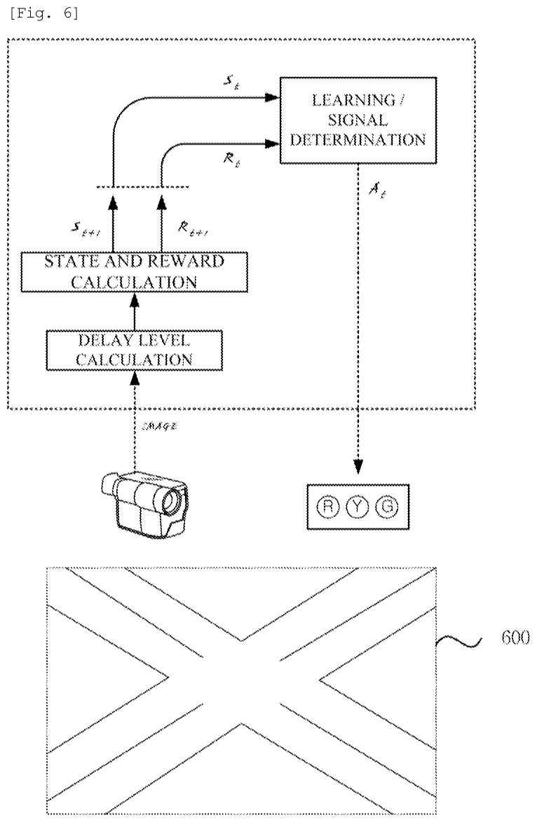

FIG. 5 is a diagram showing a general reinforcement learning model, and FIG. 6 is a diagram illustrating the reinforcement learning and signal control process of a signal control apparatus according to an embodiment.

As shown in FIG. 5, the reinforcement learning model may include an agent and an environment. In this case, the agent may be generally configured to include a ‘policy’ constituted by an artificial neural network or a lookup table, and a ‘reinforcement learning algorithm’ configured to optimize the policy for determining an action Aₜ by referring to state information and reward information given from the environment. In this case, the reinforcement learning algorithm improves the policy by referring to the state information Sₜ obtained by observing the environment, the reward Rₜ given when the state is improved in a desired direction, and the action Aₜ output according to the policy.

In addition, this process is repeated at each step. In the following, a step corresponding to the present is indicated by t, a subsequent step is indicated by t+1, and so forth.

In one embodiment, the signal control apparatus 100 may be configured such that it has an intersection as an environment, has the delay level of the intersection as state information, and sets offset time as action information, and a reward is provided when the delay level is mitigated.

In other words, as shown in FIG. 6, the delay level fₜ may be calculated from an image acquired by capturing an intersection 600 according to the above-described method. In addition, using this, the state information Sₜ may be constructed.

More specifically, the state information Sₜ may be defined as follows:

Sₜ=[fₜ]

Additionally, as the state information Sₜ, at least one of a waiting length, a waiting time, a travel speed, and a congestion level may be further added.

In addition, the reward Rₜ may be calculated based on the delay level fₜ, as follows:

Rₜ[fₜ−fₜ₊₁]

Accordingly, when the delay level is reduced at step t+1, the reward Rₜ has a positive value, so that a larger reward is given to the reinforcement learning model. Moreover, as a difference between the delay level at step t+1 and the delay level at step t increases, a larger reward Rₜ can be given, so that the reinforcement learning model can be easily trained.

Additionally, the reward Rₜ may be calculated based on at least one of a waiting length, a waiting time, a travel speed, and a congestion level.

For example, the reward Rₜ may be set to give a positive reward when the waiting length is minimized, or may be set to give a positive reward when the waiting time is minimized. Furthermore, the reward Rₜ may be set to give a positive reward when the travel speed is maximized, or may be set to give a positive reward when the congestion level is minimized.

The above-described reinforcement learning model may be configured to include a Q-network, or a DQN in which another artificial neural network is combined with the Q-network. The policy π is trained to select the action aₜ that optimizes the policy π accordingly, i.e., that maximizes the expected value of a future reward accumulated at individual training steps.

In other words, the following function is defined:

Q*(sₜ,aₜ)=max_{π} [symbol] [Rₜ+γRₜ₊₁+γ²Rₜ₊₂+ . . . |π]

In this case, in the state sₜ, training is performed to derive the optimal Q function, i.e., Q*, for the action aₜ. In addition, γ is a discount factor, and is intended to allow an action Aₜ increasing a current reward to be selected by incorporating a relatively small amount of a reward for a future step into the calculation of an expected value.

Additionally, in this case, the Q function is substantially configured in the form of a table, and thus it may be functionalized into a similar function having a new parameter using a function approximator.

Q(s,a:θ)≈Q*(s,a)

In this case, a deep-learning artificial neural network may be used, and accordingly the reinforcement learning model may be configured to include a DQN as described above.

The reinforcement learning model trained in the above manner may determine the offset time as the action aₜ based on the state information Sₜ and the reward Rₜ, and accordingly the green phase time at the second intersection may be determined, so that it may be reflected in the traffic lights S at the second intersection and ultimately affect the delay level at the first intersection.

In other words, the controller 120 may train the reinforcement learning model to acquire action information for the control of the traffic lights for the first intersection from the first agent by using the state information calculated based on the first intersection image and a reward as input values. In this case, the reinforcement learning model may be trained to calculate offset time as the action information.

Accordingly, the trained first agent may output the offset time using the state information, calculated based on the first intersection image, as an input value.

As described above, the offset time output by the first agent may be used as control information for the traffic lights at the second intersection according to an embodiment. In order to match the difference from the green light of the traffic lights at the second intersection with the offset time, the start time of the green light of the traffic lights at the first intersection may be adjusted.

According to another embodiment, the offset time output by the first agent may be used as control information for the traffic lights at the first intersection. In order to match the difference from the green light of the traffic lights at the second intersection with the offset time, the start time of the green light of the traffic lights at the first intersection may be adjusted.

As the start time of the green light at the first intersection or the second intersection is adjusted, the environment of the first intersection or the second intersection is updated, and thus the intersection image acquired by the photographing unit 110 may be changed. The changed intersection image allows the changed state information to be calculated.

The above-described process is repeated and optimizes the policy of the reinforcement learning model.

Furthermore, based on the trained reinforcement learning model, the controller 120 may input the state information calculated based on the intersection image to the agent, may generate control information according to the action information output in response to the input of the state information, and may control the traffic lights accordingly.

Meanwhile, the controller 120 may control the traffic signal at the intersection based on the multi-agent reinforcement learning model, and may additionally control the traffic signal at the intersection based on another reinforcement learning model according to the state of a local intersection.

In this case, local may mean one intersection or a predetermined number of intersection groups. For example, a plurality of intersections located in each region may be viewed as one intersection group, and the traffic signals of the intersections constituting the intersection group may be controlled according to the state of the corresponding intersection group.

As the offset time is determined based on the multi-agent reinforcement learning model, the environment of each of the first intersection and the second intersection may be set.

In this case, when oversaturation occurs at the first intersection, traffic communication may deteriorate rapidly due to spillback or the like, so that there is a need to increase a signal period at the first intersection where the oversaturation occurs.

In this case, whether the first intersection is in an oversaturated state may be determined to be oversaturated when it is determined that the congestion level of the first intersection is equal to or higher than a predetermined size and continues for a predetermined time. For example, when it is determined that a congestion level of 50% or more continues for 10 minutes, the corresponding intersection may be determined to be oversaturated. Alternatively, as to whether the first intersection is in an oversaturated state, the first intersection may be determined to be in an oversaturated state when spillback occurs at the first intersection, or the second intersection may be determined to be in an oversaturated state when spillback occurs at the first intersection.

Accordingly, according to an embodiment, when an intersection is oversaturated, the controller 120 may increase the signal period of the oversaturated intersection by adding a preset signal period to the corresponding signal period so that a vehicle located in a lane area or a driving direction causing the oversaturation can be moved, and may add a signal pattern that enables a vehicle located in a lane area or a driving direction causing the oversaturation to be moved.

Furthermore, the controller 120 may increase the signal period of all the intersections in the intersection group or add a signal pattern to all the intersections in the intersection group. Alternatively, the controller 120 may select an intersection having the highest congestion level or the longest spillback occurrence time in the intersection group, and may then increase the signal period of the corresponding intersection or add a signal pattern to the corresponding intersection.

Meanwhile, according to another embodiment, the controller 120 may increase the signal period of an oversaturated intersection or add a signal pattern based on another reinforcement learning model.

In the following description, for ease of description, the above-described multi-agent reinforcement learning model will be referred to as a first reinforcement learning model, and a reinforcement learning model different from the first reinforcement learning model will be referred to as a second reinforcement learning model.

The second reinforcement learning model may be configured to include a Q-network or a DQN in which another artificial neural network is combined with the Q-network, and may train a policy like the first reinforcement learning model. The second reinforcement learning model may include an agent and an environment. In the following description, for ease of description, the agent of the second reinforcement learning model is referred to as a third agent in order to distinguish it from the preceding first and second agents.

According to one embodiment, the controller 120 may train the second reinforcement learning model so that the second reinforcement learning model has an intersection as an environment for each intersection, the delay level of the intersection as state information, and a phase signal period (the time required to complete a given sequential phase sequence once) as an action and a reward is given when the delay level is mitigated.

Accordingly, for example, when spillback occurs at the center of the first intersection for a predetermined time so that it is determined that the first intersection is oversaturated, the controller 120 allows the third agent operating based on the second reinforcement learning model to calculate a phase signal period as action information when receiving the first intersection as an environment and the delay level of the intersection as state information, and may generate a control signal so that the traffic lights S are controlled according to the calculated signal period. In this case, when the intersection is in the oversaturated state, the controller 120 may control the traffic lights S according to a control signal based on the second reinforcement learning model instead of controlling the traffic lights S according to a control signal based on the first reinforcement learning model.

As the environment changes accordingly, the state information input to the first reinforcement learning model changes, so that the offset time calculated by the first agent at the first intersection may be changed. Accordingly, as the environment of the second intersection changes, the offset time calculated by the second agent at the second intersection may be changed.

According to another embodiment, the controller 120 may train the second reinforcement learning model so that the second reinforcement learning model has an intersection as an environment for each intersection, the delay level of the intersection as state information, and a pattern of a plurality of preset different phases as an action and a reward is given when the delay level is mitigated.

Accordingly, for example, when spillback occurs at the center of the first intersection for a predetermined time so that it is determined that the first intersection is oversaturated, the controller 120 may calculate pattern information as action information by inputting the first intersection as an environment and the delay level of the intersection as state information using the second reinforcement learning model, and may generate a control signal so that the traffic lights S are controlled according to the calculated pattern. Accordingly, for example, in a signal period in which a bidirectional through signal pattern is not included, as the third agent calculates the bidirectional through signal pattern, the bidirectional through signal pattern is included and then driving is performed, thereby increasing a total signal period.

When the oversaturated state is resolved (the corresponding intersection is determined not to be in the oversaturated state) as described above, the controller 120 may control the traffic lights S according to the first reinforcement learning model. In this case, according to the embodiment, while the second reinforcement learning model is used to resolve the oversaturated state of the first intersection, signal control at the other intersection may be performed according to the first reinforcement learning model.

Meanwhile, the above-described method for resolving the oversaturation of an intersection based on the second reinforcement learning model may be equally applied to the resolution of the oversaturation of an intersection constituting a part of an intersection group.

Meanwhile, the controller 120 may view the intersection group as one intersection, in which case the controller 120 may set an entry through which a vehicle enters into the intersection group as the entry point of the intersection and set an exit through which a vehicle exits from the intersection group as the exit of the intersection. Therefore, the controller 120 may treat the corresponding intersection group as one intersection.

Accordingly, according to one embodiment, the controller 120 may train the second reinforcement learning model so that the second reinforcement learning model has a phase signal cycle as an action when the delay level of the intersection group is input as state information and a reward is provided when the delay level is mitigated. When a phase signal period is calculated as the delay level of the intersection group is input to the third agent of the trained second reinforcement learning model, the controller 120 may adjust the phase signal period of each intersection constituting a part of the intersection group. For example, the phase signal periods of all intersections included in the intersection group may be increased.

According to still another embodiment, the controller 120 may set an intersection group as one intersection, and may train the second reinforcement learning model so that the second reinforcement learning model has the intersection group as an environment, the delay level of the intersection group as state information, and pattern information as an action and a reward is provided when the delay level is mitigated. When pattern information is calculated as the delay level of the intersection group is input to the third agent of the trained second reinforcement learning model, the controller 120 may adjust the pattern information by adding corresponding pattern information at each intersection constituting a part of the intersection group. For example, a bidirectional through signal pattern may be added to the pattern information of all intersections included in the intersection group.

Meanwhile, the first reinforcement learning model and the second reinforcement learning model described above may be used after being trained. In this case, the reinforcement learning algorithms included in the reinforcement learning models are not used, and only policies may be used.

More specifically, the controller 120 may train the reinforcement learning model in advance before determining a subsequent signal using the policy of the reinforcement learning model and generating a control signal corresponding to the determined subsequent signal so that the traffic lights S can be controlled. It is obvious that training and the determination of a signal may be performed simultaneously by continuously using a reinforcement learning algorithm.

In connection with this, the controller 120 may distinguish a learning target environment and an inference target environment from each other.

For example, the controller 120 may training a reinforcement learning model based on intersection images acquired from a traffic simulation environment constructed based on preset variable values and traffic patterns, and may perform inference based on an intersection image acquired by capturing an intersection. In other words, after the reinforcement learning model has been trained, an inference process is performed according to the need to find and cut out a part that is not activated or to fuse the computational steps of layers constituting the reinforcement learning model. Resources and time required for inference may be reduced by performing inference using an intersection image acquired by capturing an actual intersection. In addition, the conventional technology has problems in that an accident occurs or traffic becomes congested because a learning target environment and a control target environment are different from each other. Inference is performed according to the present embodiment, so that traffic flow may be safely controlled without an accident when the present invention is applied to the control target environment.

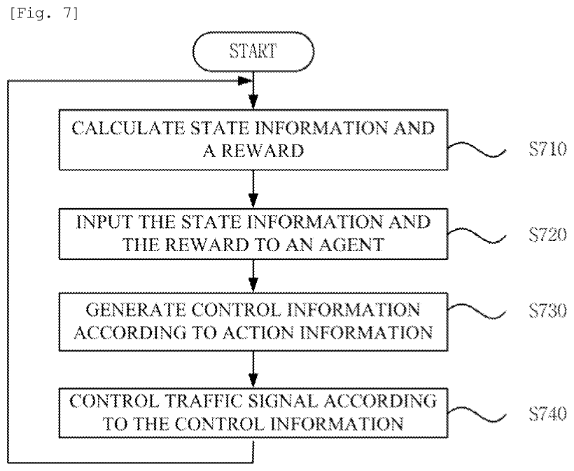

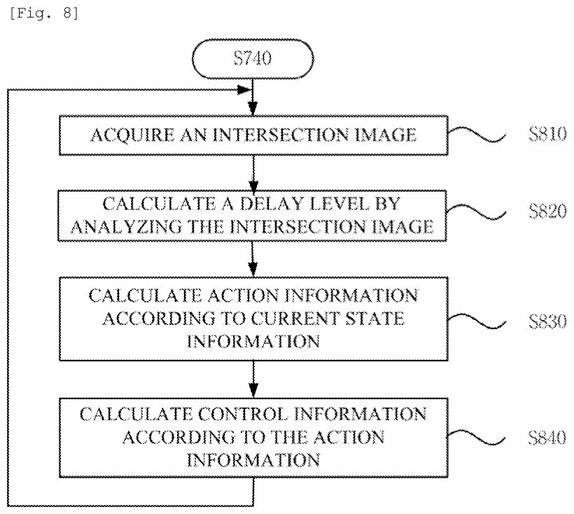

Meanwhile, FIG. 7 is a flowchart showing the process of performing reinforcement learning in a signal control method according to an embodiment in a stepwise manner, and FIG. 8 is a flowchart showing the process of controlling traffic lights using a reinforcement learning model in a signal control method according to an embodiment in a stepwise manner.

The signal control method shown in FIGS. 7 and 8 includes steps that are performed in a time-series manner in the signal control apparatus 100 described via FIGS. 1 to 6. Accordingly, the descriptions that are omitted below but are given above in conjunction with the signal control apparatus 100 shown in FIGS. 1 to 6 may also be applied to the signal control method according to the embodiment shown in FIGS. 7 and 8.

As shown in FIG. 7, the signal control apparatus 100 calculates state information and reward information at step S710. In this case, a delay level may be calculated as the state information, and a delay level may be computed.

In this case, the state information may be a delay level calculated based on arrival traffic and through traffic for a predetermined time as described above, and the reward may be a value converted in proportion to the delay level.

In addition, the signal control apparatus 100 may train a reinforcement learning model-based agent for controlling an action for the control of traffic lights at an intersection by using the state information and the reward as input values.

In other words, the signal control apparatus 100 may input the calculated state information and reward information to the agent of the reinforcement learning model at step S720, and may generate control information based on the action information output by the agent at step S730. In addition, the signal control apparatus 100 may control the signal of the learning target intersection according to the control information at step S740.

In other words, according to an embodiment, the signal control apparatus 100 may train the reinforcement learning model so that the reinforcement learning model acquires action information for the control of traffic lights at the second intersection from the first agent by using state information, calculated based on the first intersection image, as an input value.

According to another embodiment, the signal control apparatus 100 may train the reinforcement learning model so that the reinforcement learning model acquires offset time as action information from the first agent by using state information, calculated based on the first intersection image, as an input value.

In this case, the above-described steps S710 to S740 are repeatedly performed. In this process, an optimal Q function may be calculated.

Accordingly, the reinforcement learning model may be trained by repeating the above-described steps S710 to S740.

Meanwhile, referring to FIG. 8, the process of controlling traffic lights using the reinforcement learning model trained by repeating steps S710 to S740 is now described. First, the signal control apparatus 100 may acquire an intersection image obtained by capturing an actual intersection at step S810.

In this case, according to the embodiment, the signal control device 100 may allow an agent to operate for each intersection. Accordingly, at each intersection, each agent outputs action information using state information, calculated based on an intersection image acquired by capturing the intersection, as an input value. Therefore, it may be possible to control not only traffic lights at each intersection, but also traffic lights at a subsequent intersection.

Accordingly, the signal control apparatus 100 may calculate a delay level by analyzing the intersection image at step S820. In addition, at step S830, the signal control device 100 may calculate current state information by using the delay level calculated at step S820.

Then, the signal control apparatus 100 may calculate control information according to the action information at step S840. Thereafter, the signal control apparatus 100 may apply a drive signal to the traffic lights S according to the calculated control information.

It is obvious that in this case, the signal control apparatus 100 may additionally train the reinforcement learning model while performing the process shown in FIG. 8 as described above.

Furthermore, when it is determined that the intersection is oversaturated, the signal control device 100 may stop the agent from calculating the offset time as action information according to the trained reinforcement learning model, and may allow the agent to calculate period time or pattern information according to another reinforcement learning model.

According to an embodiment, when it is determined that the first intersection is oversaturated, the signal control apparatus 100 may calculate a signal period based on the first intersection image by using a reinforcement learning model trained to output a signal period for the control of traffic lights at the first intersection as action information using the state information, extracted from the first intersection image, as an input value.

According to another embodiment, when it is determined that the first intersection is oversaturated, the signal control apparatus 100 may calculate a signal pattern based on the first intersection image by using a reinforcement learning model trained to output a signal period for the control of traffic lights at the first intersection as action information using the state information, extracted from the first intersection image, as an input value.

The signal control method described above may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

The signal control method described above may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

The signal control method described above may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and ‘unit(s)’ may be coupled to a smaller number of components and ‘unit(s)’ or divided into a larger number of components and ‘unit(s).’

In addition, components and ‘unit(s)’ may be implemented to run one or more CPUs in a device or secure multimedia card. The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention.

1. A signal control apparatus for controlling traffic signals at intersections based on a reinforcement learning model, the signal control apparatus comprising:
a photographing unit configured to acquire a plurality of intersection images by capturing a plurality of intersections;
a storage configured to store a program for control of traffic signals; and
a controller comprising at least one processor, and configured to calculate control information for control of traffic lights at each of the plurality of intersections using the intersection images acquired through the photographing unit by executing the program;
wherein the controller calculates control information for control of traffic lights at each of the plurality of intersections based on action information calculated by a plurality of agents, to which state information calculated based on each of the plurality of intersection images is input, by using a plurality of agents based on a reinforcement learning model trained by outputting action information for control of traffic lights while using state information and a reward as input values.

2. The signal control apparatus of claim 1, wherein the controller calculates a delay level at an intersection corresponding to an intersection image as state information, in which case the delay level is calculated based on arrival traffic and through traffic for a predetermined time.

3. The signal control apparatus of claim 1, wherein the controller trains the reinforcement learning model to acquire action information for control of traffic lights at a second intersection from a first agent by using state information, calculated based on an intersection image of a first intersection, which is one of the plurality of intersections, as an input value.

4. The signal control apparatus of claim 3, wherein the controller trains the reinforcement learning model to acquire, as the action information, an offset time related to a time difference between a start time of a green light of traffic lights at the first intersection and a start time of a green light of traffic lights at the second intersection.

5. The signal control apparatus of claim 1, wherein the controller, when it is determined that a first intersection, which is one of the plurality of intersections, is in an oversaturated state, calculates a signal period based on an intersection image of the first intersection by using a reinforcement learning model trained to output a signal period for control of traffic lights at the first intersection as action information by using state information extracted from the intersection image of the first intersection as an input value.

6. The signal control apparatus of claim 1, wherein the controller, when it is determined that a first intersection, which is one of the plurality of intersections, is in an oversaturated state, calculates a signal pattern based on an intersection image of the first intersection by using a reinforcement learning model trained to output a signal pattern for control of traffic lights at the first intersection as action information by using state information extracted from the intersection image of the first intersection as an input value.

7. The signal control apparatus of claim 1, wherein the controller trains the reinforcement learning model to output action information for control of traffic lights by using state information and a reward as input values, in which case the reward is increased in proportion to a delay level.

8. The signal control apparatus of claim 1, wherein the reinforcement learning model is trained based on intersection images acquired from a traffic simulation environment constructed based on preset variable values and traffic patterns, and performs inference based on an intersection image acquired by capturing an intersection.

9. A signal control method by which a signal control apparatus controls traffic signals at intersections based on a reinforcement learning model, the signal control method comprising:
training a reinforcement learning model so that an agent outputs action information for control of traffic lights by using state information and a reward as input values;
acquiring a plurality of intersection images by capturing a plurality of intersections; and
calculating control information for control of traffic lights at each of the plurality of intersections by using the acquired intersection images;
wherein calculating the control information comprises calculating control information for control of traffic lights at each of the plurality of intersections based on action information calculated by a plurality of agents, to which state information calculated based on each of the plurality of intersection images is input, by using a plurality of agents based on the trained reinforcement learning model.

10. The signal control method of claim 9, wherein training the reinforcement learning model comprises calculating a delay level at an intersection corresponding to an intersection image as state information, in which case the delay level is calculated based on arrival traffic and through traffic for a predetermined time.

11. The signal control method of claim 9, wherein training the reinforcement learning model comprises training the reinforcement learning model to acquire action information for control of traffic lights at a second intersection from a first agent by using state information, calculated based on an intersection image of a first intersection, which is one of the plurality of intersections, as an input value.

12. The signal control method of claim 11, wherein training the reinforcement learning model comprises training the reinforcement learning model to acquire, as the action information, an offset time related to a time difference between a start time of a green light of traffic lights at the first intersection and a start time of a green light of traffic lights at the second intersection.

13. The signal control method of claim 9, wherein calculating the control information further comprises, when it is determined that a first intersection, which is one of the plurality of intersections, is in an oversaturated state, calculating a signal period based on an intersection image of the first intersection by using a reinforcement learning model trained to output a signal period for control of traffic lights at the first intersection as action information by using state information extracted from the intersection image of the first intersection as an input value.

14. The signal control method of claim 9, wherein calculating the control information further comprises, when it is determined that a first intersection, which is one of the plurality of intersections, is in an oversaturated state, calculating a signal pattern based on an intersection image of the first intersection by using a reinforcement learning model trained to output a signal pattern for control of traffic lights at the first intersection as action information by using state information extracted from the intersection image of the first intersection as an input value.
